(19) United States
(12) Patent Application Publication
(10) Pub. No.: US 2012/0023379 A1
(43) Pub. Date: Jan. 26, 2012

(54) STORAGE DEVICE, STORAGE SYSTEM, AND CONTROL METHOD

(75) Inventor: Hironori KAI, Kawasaki (JP)

(73) Assignee: FUJITSU LIMITED, Kawasaki-shi (JP)

(21) Appl. No.: 13/083,692

(22) Filed: Apr. 11, 2011

(30) Foreign Application Priority Data
Jul. 23, 2010 (JP) 2010-166353

(51) Int. Cl. G06F 11/07

(52) U.S. Cl. 714/57; 714/E11.025

(57) ABSTRACT

A storage device stores the types of errors together with the details of processes to be executed by a control device that controls the storage device when an error occurs so as to associate the types of the errors with the details of the processes. The storage device detects an error that occurs therein and determines the type of the detected error. The storage device acquires the details of the stored process associated with the determined type of the error and transmits the acquired details of the process to the control device. More specifically, the storage device is controlled by the control device such that the transmitted details of the process are executed.

### CROSS-REFERENCE TO RELATED APPLICATIONS

This application is based upon and claims the benefit of priority of the prior Japanese patent application No. 2010-166353, filed on Jul. 23, 2010, the entire contents of which are incorporated herein by reference.

### FIELD

The embodiments discussed herein are directed to a storage device, a storage system, and a control method.

### BACKGROUND

In one known storage system, a plurality of storage devices (for example, disk array devices) and a control device for controlling each of the storage devices (for example, a server device for controlling the disk array devices) are connected via a network. In such a storage system, various errors such as a high I/O (Input-Output) load, notification of a failure of a constituent module, and notification of an information level can occur between the storage devices and the control device. If an error occurs in a storage device, the storage device generates error information uniquely identifying the type of the error and transmits the generated error information to the control device.

The control device has a table in which the details of processing to be executed when errors occur are stored in association with the information of the errors. For example, the control device stores, in association with the information of an error, the contents of an error message, a retry number, a failover number, and other information as the details of the processing to be executed when the error occurs.

Upon reception of error information from a storage device, the control device acquires, from the table, the details of the processing associated with the received error information and executes the processing including the acquired details. For example, upon reception of error information, the control device executes a process for displaying an error message associated with the received error information on a client and other processes such as a predetermined number of retries and a predetermined number of failover attempts. More specifically, the relationships between the error information and the details of the processing have been hard-coded into programs executed by the control device.

In such a storage system, when new error information is added or the details of processing to be executed are modified, all programs associated with the error information and to be executed by the control device are modified. Then the control device is rebooted so that the modified programs can be executed.

However, with the above-described technology in which the control device (such as a server device) stores the details of processing for errors, the control device itself determines the details of the processing for an error in a storage device. Therefore, one problem with this technology is that the control device cannot determine processing appropriate for the error in the storage device. More specifically, the control device determines the processing for the error using a unique algorithm of the control device irrespective of the state of the storage device, and therefore the processing executed may not be appropriate for the error in the storage device.

With the above-described technology in which the control device stores the details of processing for errors, when the details of processing to be executed upon occurrence of an error are modified, programs are modified, and the control device is rebooted. Therefore, another problem is that addition of new details to the processing and modifications to the details of the processing cannot be made in an efficient manner.

More specifically, with the above-described technology in which the control device stores details of processing for errors, since programs used in the control device must be modified each time details are added to the processing or the details of the processing are modified, the load of the modification work is large. Moreover, since the control device must be rebooted after the programs are modified, the services that use the storage system are stopped during reboot of the control device.
Patent Document: Japanese National Publication of International patent application No. 2006-524864

### SUMMARY

According to an aspect of an embodiment of the invention, a storage device includes an error processing information table storing unit that stores a table that associates types of possible errors that can occur in the storage device with details of processes to be executed when the possible errors occur; a determination unit that detects occurrence of an error in the storage device and determining a type of the error in the storage device; an acquisition unit that acquires, from the error processing information table storing unit, the details of the stored process associated with the type of the error that is determined by the determination unit; and a transmission unit that transmits the details of the process acquired by the acquisition unit to a control device that controls the storage device.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating a storage device according to a first embodiment;

FIG. 2 is a block diagram illustrating a storage system according to a second embodiment;

FIG. 3 illustrates examples of dynamic information and static information;

FIG. 4 is a diagram illustrating a process for storing the dynamic information;

FIG. 5 is a diagram illustrating the configuration image of the storage system according to the second embodiment;

FIG. 6 is a diagram illustrating an example of the static information;

FIG. 7 is a diagram illustrating the transfer of dynamic information;

FIG. 8 is a diagram illustrating the transfer of static information;

FIG. 9 is a flow chart illustrating the transmission process of dynamic information;

FIG. 10 is a flow chart illustrating the generation process of the dynamic information;

FIG. 11 is a flow chart illustrating the transmission process of static information; and

FIG. 12 is a diagram illustrating a computer that executes processing programs.

### DESCRIPTION OF EMBODIMENTS

Preferred embodiments of the present invention will be explained with reference to accompanying drawings. However, the present invention is not limited to the embodiments described below.

### [a] First Embodiment

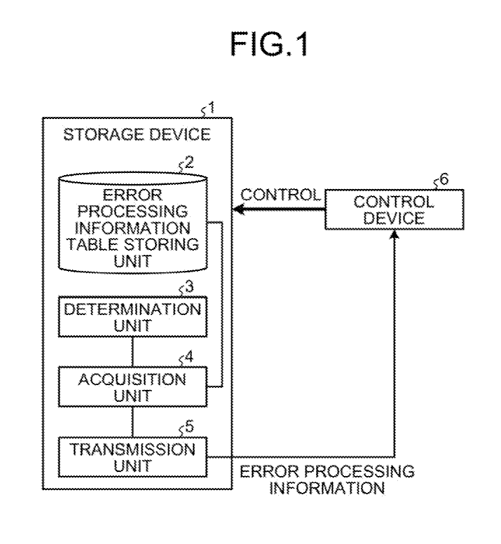

In a first embodiment described below, an example of the storage device will be described with reference to FIG. 1. FIG. 1 is a block diagram illustrating the storage device according to the first embodiment.

As illustrated in FIG. 1, a storage device 1 according to the first embodiment includes an error processing information table storing unit 2, a determination unit 3, an acquisition unit 4, and a transmission unit 5. The storage device 1 is connected to a control device 6 that controls the storage device 1.

The error processing information table storing unit 2 stores a table that associates the types of errors that can occur in the storage device 1 with the details of processing to be executed when the errors occur. The determination unit 3 detects the occurrence of an error in the storage device 1 and determines the type of the detected error.

The acquisition unit 4 acquires, from the error processing information table storing unit 2, the details of the stored processing associated with the type of the error determined by the determination unit 3. The transmission unit 5 transmits the details of the processing acquired by the acquisition unit 4 to the control device 6 that controls the storage device 1. Then the control device 6 controls the storage device 1 to execute the processing including the received details.

As described above, in the storage device 1 according to the first embodiment, the types of errors and processing to be executed by the control device 6 when the errors occur are stored in association with each other. When an error occurs, the details of the processing associated with the type of the error are transmitted to the control device 6. Therefore, the control device 6 can control the storage device 1 such that processing appropriate for the error that has occurred in the storage device 1 is executed.

A description will be given of an example in which the control device 6 controls the storage device 1 and a storage device 1a having the same functions as those of the storage device 1. The control device 6 can control the storage devices 1 and 1a such that, even when the same type of errors occur but processing appropriate for the storage device 1 and processing appropriate for the storage device 1a are different, the numbers of retries attempted are appropriate for the storage devices 1 and 1a.

When new processing details are added or the details of processing are modified, the storage device 1 updates only the error processing information table storing unit 2. Therefore, in the storage device 1 according to the first embodiment, when processing details are added or modified, it is not necessary to reboot the control device 6, and the addition of processing details or modifications to the details of processing can be made in an efficient manner.

### [b] Second Embodiment

In a second embodiment described below, the configuration of a storage system and its processing flows will be described.

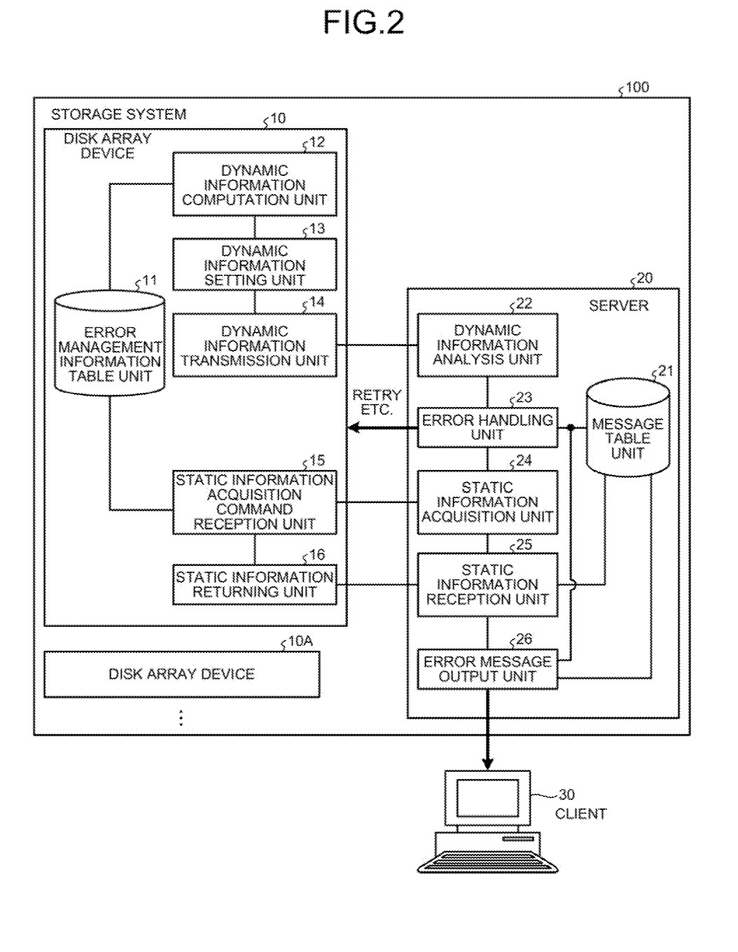

First, the components of the storage system according to the second embodiment will be described with reference to FIG. 2. FIG. 2 is a block diagram illustrating the storage system according to the second embodiment. As illustrated in FIG. 2, a storage system 100 includes a disk array device 10, a disk array device 10A, and a server 20. The storage system 100 is connected to a client 30. The disk array devices 10 and 10A and the server 20 are connected via a network such as an SAN (Storage Area Network).

As illustrated in FIG. 2, the disk array device 10 includes an error management information table unit 11, a dynamic information computation unit 12, a dynamic information setting unit 13, a dynamic information transmission unit 14, a static information acquisition command reception unit 15, and a static information returning unit 16.

In the following description, each of the disk array devices 10 and 10A includes a storage device such as an HDD (Hard Disk Drive) or an SSD (Solid State Drive) that stores information, but the storage device is omitted in FIG. 2. The disk array device 10A has the same configuration as that of the disk array device 10 and executes the same functions as those of the disk array device 10, and a redundant description is omitted.

First, the units 11 to 16 included in the disk array device 10 will be described. The error management information table unit 11 stores the types of errors that can occur in the disk array device 10 together with the details of processing executed by the server 20 when the errors occur so as to associate the types of errors with the details of the processing. The disk array device 10 also stores, as the details of processing, the details of dynamic processing that can be changed according to the state of the disk array device 10 each time an error is detected and the details of static processing predetermined for each of the types of the errors in association with the types of the errors.

More specifically, the error management information table unit 11 stores sense information (information indicating the type of an error) together with error handling information indicating the details of processing executed by the server 20 when the error occurs so as to associate the sense information with the error handling information. That is, the error management information table unit 11 stores, as the error handling information, dynamic information that indicates the details of processing that can be changed according to the state of the disk array device 10 each time an error is detected. The error management information table unit 11 also stores static information that indicates the details of processing predetermined for each type of error.

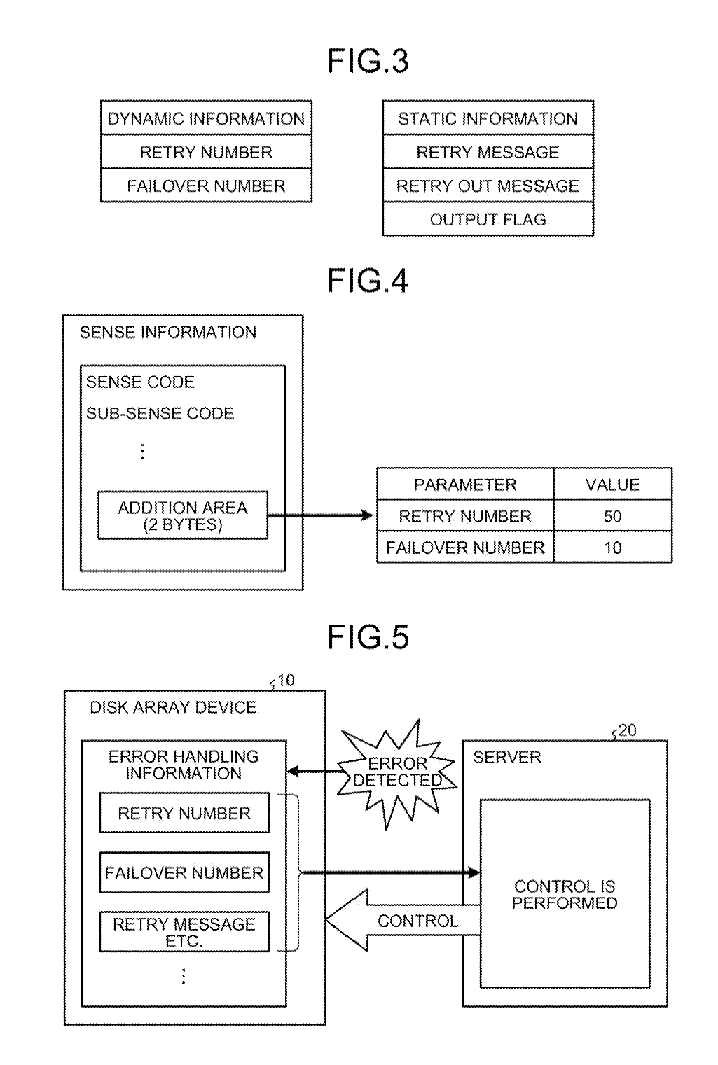

In an example illustrated in FIG. 3, the error management information table unit 11 stores, as the dynamic information, a retry number and a failover number that are included in the error handling information. The error management information table unit 11 also stores, as the static information, a retry message, a retry out message, and an output flag that are included in the error handling information.

The retry number is the number of retries to be attempted when an error occurs. The failover number is the upper limit of the number of failover attempts when an error occurs in an HDD and data is transferred from the faulty HDD to another HDD. The retry message is a message displayed on the client 30 each time a retry is attempted.

The retry out message is a massage displayed on the client 30 when retries are continuously attempted on a second path after a predetermined number of retries have been attempted on a first path. The output flag is information indicating whether or not the retry message is displayed on the client 30 each time a retry is attempted. For example, when the output flag is “ON”, an error message output unit 26 described later does not allow the retry message to be displayed and allows only the retry out message to be displayed. FIG. 3 illustrates examples of the dynamic information and the static information.

For example, the error management information table unit 11 stores, as sense information, a sense code “4” and a sub-sense code “⅔” together with a single path retry number “50” and a failover number “10” so as to associate the codes with the numbers. The error management information table unit 11 also stores a retry message “Notice disk error” as an output message together with the sense code “4” and the sub-sense code “⅔” so as to associate the retry message with the codes.

The error management information table unit 11 also stores a retry out message “WARN disk not empty” as an output message together with the sense code “4” and the sub-sense code “⅔” so as to associate the retry out message with the codes. The error management information table unit 11 also stores an output flag “ON” together with the sense code “4” and the sub-sense code “⅔” so as to associate the output flag with the codes.

Returning to FIG. 2, the dynamic information computation unit 12 detects the occurrence of an error in the storage system 100 and determines the type of the detected error. When an error is detected, the dynamic information computation unit 12 acquires dynamic information associated with the type of the detected error from the error management information table unit 11. Then the dynamic information computation unit 12 modifies the acquired dynamic information according to the state of the disk array device 10.

More specifically, the dynamic information computation unit 12 detects the occurrence of an error in the storage system 100. Upon detection of the error, the dynamic information computation unit 12 determines the type of the detected error and generates sense information indicating the determined type of the error. Then the dynamic information computation unit 12 transmits the generated sense information to the dynamic information setting unit 13.

The dynamic information computation unit 12 also searches for error handling information associated with the generated sense information from the error management information table unit 11. Then the dynamic information computation unit 12 acquires a retry number and a failover number (dynamic information) from the error handling information searched for.

After acquisition of the retry number and the failover number, the dynamic information computation unit 12 determines whether or not a second error has previously occurred in the disk array device 10 and the server 20. If a determination is made that no second error has occurred, the dynamic information computation unit 12 notifies the dynamic information setting unit 13 of the acquired retry number and failover number.

If a determination is made that a second error has occurred, the dynamic information computation unit 12 determines the type of the determined second error. Then the dynamic information computation unit 12 generates sense information indicating the type of the determined second error. Next, the dynamic information computation unit 12 searches for error handling information associated with the generated sense information from the error management information table unit 11.

The dynamic information computation unit 12 then acquires a retry number and a failover number (dynamic information) from the error handling information searched for. More specifically, the dynamic information computation unit 12 acquires not only the retry number and failover number for the new error but also the retry number and failover number for the error that has previously occurred.

Then the dynamic information computation unit 12 adds the acquired retry numbers together. The dynamic information computation unit 12 also adds the acquired failover numbers together. Then the dynamic information computation unit 12 notifies the dynamic information setting unit 13 of the resultant retry number and the resultant failover number. More specifically, the dynamic information computation unit 12 acquires the retry number and failover number changed according to the error occurrence state of the storage system 100 and notifies the dynamic information setting unit 13 of these retry number and failover number.

A specific example of the processing executed by the dynamic information computation unit 12 will next be described. In the following example, it is assumed that a sense code “4” and a sub-sense code “⅔” have been stored in the error management information table unit 11 together with a retry number “20” and a failover number “5” so as to associate the codes with the numbers. It is also assumed that a sense code “4” and a sub-sense code “⅓” have been stored in the error management information table unit 11 together with a retry number “30” and a failover number “5” so as to associate the codes with the numbers. In addition, it is assumed that an error of the type indicated by a sense code “4” and a sub-sense code “⅓” occurs in the disk array device 10 and then a new error of the type indicated by a sense code “4” and a sub-sense code “⅔” occurs.

For example, when the new error occurs, the dynamic information computation unit 12 determines the type of the new error and generates a sense code “4” and a sub-sense code “⅔” as sense information that indicate the determined type of the error. Then the dynamic information computation unit 12 transmits the generated sense code “4” and sub-sense code “⅔” to the dynamic information setting unit 13.

The dynamic information computation unit 12 also acquires a retry number “20” and a failover number “5” that have been stored in the error management information table unit 11 in association with the sense code “4” and the sub-sense code “⅔”. Then the dynamic information computation unit 12 determines whether or not a second error has occurred in the disk array device 10 and the server 20.

In the above case, the dynamic information computation unit 12 makes a determination that an error of the type indicated by a sense code “4” and a sub-sense code “⅓” has already occurred. Therefore, the dynamic information computation unit 12 acquires the retry number “30” and the failover number “5” that have been stored in association with the sense code “4” and the sub-sense code “⅓” from the error management information table unit 11.

Then the dynamic information computation unit 12 adds the retry number “20” stored in association with the sense code “4” and the sub-sense code “⅔” to the retry number “30” stored in association with the sense code “4” and the sub-sense code “⅓”, and the resultant retry number “50” is obtained. The dynamic information computation unit 12 also adds the failover number “5” stored in association with the sense code “4” and the sub-sense code “⅔” to the retry number “5” stored in association with the sense code “4” and the sub-sense code “⅓”, and the resultant retry number “10” is obtained. Then the dynamic information computation unit 12 notifies the dynamic information setting unit 13 of the computed retry number “50” and the computed failover number “10”.

In the above description, the dynamic information computation unit 12 computes the sums of the retry number and failover number associated with the type of the new error and the retry number and the failover number associated with the error that has already occurred. However, the processing executed by the dynamic information computation unit 12 to modify the error handling information according to the state of the disk array device 10 is not limited to the above processing.

For example, the dynamic information computation unit 12 may store the history of errors that have occurred in the disk array device 10 and may increase or decrease the retry number and failover number according to the types of the errors that have occurred or the numbers of occurrences of these errors. In such a case, it is not necessary to determine whether or not another error has occurred. The dynamic information computation unit 12 may not simply add the retry numbers together and the failover numbers together. For example, the dynamic information computation unit 12 may compute a new retry number and a new failover number using coefficients determined according to the history of the errors and the timing of the occurrence of each error. In the dynamic information computation unit 12, the upper and lower limits of the retry number and failover number may be provided.

The dynamic information setting unit 13 stores the dynamic information in an addition area of the sense information including the information of the type of the error determined by the determination unit. More specifically, the dynamic information setting unit 13 stores the dynamic information transmitted from the dynamic information computation unit 12 in the addition area of the sense information received from the dynamic information computation unit 12. Then the dynamic information setting unit 13 transmits the sense information including the dynamic information stored therein to the dynamic information transmission unit 14.

The processing executed by the dynamic information setting unit 13 to store the dynamic information in the addition area of the sense information will next be described. In the disk array device 10 in which an SAN environment is used, error handling information cannot be transmitted to the server 20 together with rear/write data using DMA (Direct Memory Access) transmission. In addition, in the above system in which a new command is transmitted from the server 20 to the disk array device 10 to request both the dynamic information and static information, the server 20 transmits a new command each time an I/O (Input Output) retry is attempted. This may cause deterioration in I/O performance.

Therefore, as exemplified in FIG. 4, the disk array device 10 generates sense information when an I/O is issued and then provides a 2-byte addition area in the generated sense information. Then the disk array device 10 stores error handling information in this addition area. The 2-byte addition area cannot store the entire error handling information. Therefore, the disk array device 10 stores only the retry number and the failover number (dynamic information) included in the error handling information stored in the addition area of the sense information.

In this manner, the disk array device 10 can store the error handling information in the addition area of the sense information and can transmit the dynamic information in the error handling information to the server 20 without any deterioration in I/O performance. Since the disk array device 10 transmits the sense information and the dynamic information simultaneously, the server 20 can be notified in real time of the occurrence of the error and the details of the processing to be executed, and the control can be performed on demand.

In the example illustrated in FIG. 4, the dynamic information setting unit 13 acquires a retry number “50” and a failover number “10” as dynamic information from the dynamic information computation unit 12. Then the dynamic information setting unit 13 stores the acquired retry number “50” and failover number “10” in the addition area of the sense information. More specifically, the dynamic information setting unit 13 places the dynamic information in the addition area of the sense information in a forced manner. Then the dynamic information setting unit 13 transmits the sense information including the retry number and failover number stored therein to the dynamic information transmission unit 14. FIG. 4 is a diagram illustrating the processing for storing the dynamic information.

Returning to FIG. 2, the dynamic information transmission unit 14 transmits, to the server 20, the sense information that indicates the details of the processing acquired by the dynamic information computation unit 12 and the type of the detected error. More specifically, the dynamic information transmission unit 14 receives the sense information including the dynamic information stored therein from the dynamic information setting unit 13. Then the dynamic information transmission unit 14 transmits the sense information received from the dynamic information setting unit 13 to the server 20.

Upon reception of a processing request for notification of the details of static processing from a static information acquisition unit 24 (described later) of the server 20, the static information acquisition command reception unit 15 acquires the details of the requested static processing from the error management information table unit 11. More specifically, the static information acquisition command reception unit 15 receives a static information acquisition command including a sense code and a sub-sense code stored therein from the static information acquisition unit 24 (described later) of the server 20.

Then the static information acquisition command reception unit 15 analyzes the received static information acquisition command to acquire the sense code and the sub-sense code stored in the static information acquisition command. The static information acquisition command reception unit 15 also acquires an output massage and other information associated with the acquired sense code and sub-sense code from the error management information table unit 11. Then the static information acquisition command reception unit 15 transmits the acquired output massage and other information to the static information returning unit 16.

For example, the static information acquisition command reception unit 15 receives a static information acquisition command including a sense code “4” and a sub-sense code “⅔” stored therein from the server 20. In such a case, the static information acquisition command reception unit 15 acquires an output message associated with the sense code “4” and the sub-sense code “⅔” from the error management information table unit 11.

Therefore, the static information acquisition command reception unit 15 acquires a retry message “Notice disk error” and an error message “WARN disk not empty” from the error management information table unit 11. The static information acquisition command reception unit 15 also acquires an output flag “ON” from the error management information table unit 11. Then the static information acquisition command reception unit 15 transmits the acquired static information to the static information returning unit 16.

The static information returning unit 16 transmits the details of the static processing acquired by the static information acquisition command reception unit 15 to the server 20. More specifically, the static information returning unit 16 receives the static information acquired by the static information acquisition command reception unit 15. Then the static information returning unit 16 transmits the received static information to the server 20.

As described above, in the storage system 100, the error handling information is stored in the disk array device 10, and this allows the server 20 to execute processing appropriate for the disk array device 10. For example, as illustrated in FIG. 5, when an error is detected, the disk array device 10 transmits error handling information appropriate therefor to the server 20.

As described later, the server 20 controls the disk array device 10 such that the processing indicated by the received error handling information is executed. Therefore, the disk array device 10 can execute processing appropriate for the error that has occurred therein. More specifically, in the storage system 100, even when the processing appropriate for a certain error is different for each of the disk array devices 10 and 10A, the server 20 can control the disk array devices 10 and 10A such that appropriate processing is executed. FIG. 5 is a diagram illustrating the configuration image of the storage system according to the second embodiment.

In addition, in the storage system 100, the contents of the dynamic information are modified according to the state of the disk array device 10, and therefore the server 20 can control the disk array device 10 such that processing appropriate for the error that has occurred therein is executed. However, in a conventional server, processing appropriate for an error that has occurred in a disk array device cannot be executed.

For example, in the conventional server, sense information for a sense error “UnitAttention” is stored together with the details of associated processing (40 retries), and sense information for a sense error “HardError” is stored together with the details of associated processing (10 retries). In such a conventional server, if sense information indicating the sense error “HardError” is received after 15 retries out of 40 retries for the sense error “UnitAttention” have been attempted, a determination is made that 15 retries have already been attempted.

Therefore, the conventional server makes a determination that the number of retries for the sense error “HardError” has exceeded a threshold value and then returns an error to a failover or host program even when 40 retries for the sense error “UnitAttention” have not been completed. More specifically, the conventional server cannot determine processing appropriate for an error in the disk array system.

However, in the disk array device 10 according to the second embodiment, the retry numbers associated with the information indicating sense errors are summed, and the resultant number of retries are attempted by the server 20. More specifically, since the disk array device 10 notifies the server 20 of the processing appropriate for the errors that have occurred in the disk array device 10, the server 20 can control the disk array device 10 such that the appropriate processing is executed.

In the storage system 100, when addition and modification are made to error handling information, only the error management information table unit 11 of the disk array device 10 is modified, so that it is not necessary to reboot the server 20. Therefore, in the storage system 100, the addition and modification can be made to the error handling information in an efficient manner.

Returning to FIG. 2, the server 20 includes a message table unit 21, a dynamic information analysis unit 22, an error handling unit 23, the static information acquisition unit 24, a static information reception unit 25, and the error message output unit 26.

The message table unit 21 stores the type of an error together with the details of static processing so as to associate the type of the error with the details of static processing. More specifically, the message table unit 21 stores sense information together with output messages (a retry message and a retry out message) and an output flag so as to associate the sense information with the output messages and the output flag.

For example, the message table unit 21 stores a retry message “Notice disk error” together with a sense code “4” and a sub-sense code “⅔″ (sense information) so as to associate the retry message with the codes. The message table unit 21 also stores an error message “WARN disk not empty” (output message) together with the sense code “4” and the sub-sense code “⅔” so as to associate the error message with the codes. The message table unit 21 also stores an output flag “ON” together with the sense code “4” and the sub-sense code “⅔” so as to associate the output flag with the codes.

Upon reception of sense information including the details of dynamic processing stored therein from the disk array device 10, the dynamic information analysis unit 22 analyzes the received sense information to acquire the details of the dynamic process stored in the sense information. More specifically, upon reception of the sense information, the dynamic information analysis unit 22 analyzes the received sense information to acquire the retry number, failover number, sense code, and sub-sense code stored in the addition area of the sense information.

Then the dynamic information analysis unit 22 notifies the error handling unit 23 of the acquired retry number and failover number. The dynamic information analysis unit 22 also notifies the error handling unit 23 the acquired sense code and sub-sense code.

Upon reception of the details of the processing from the disk array device 10, the error handling unit 23 executes the processing including the received details. Upon reception of the sense information from the disk array device 10, the error handling unit 23 determines whether or not the details of the static processing associated with the type of the error indicated by the received sense information have been stored in the server 20.

More specifically, the error handling unit 23 acquires the retry number and the failover number from the dynamic information analysis unit 22. Then the error handling unit 23 repeats a retry until the acquired retry number is reached. The error handling unit 23 also repeats a failover process until the acquired failover number is reached.

The error handling unit 23 also acquires the sense code and the sub-sense code (sense information) from the dynamic information analysis unit 22. After acquisition of the sense code and the sub-sense code, the error handling unit 23 determines whether or not the static information associated with the acquired sense code and sub-sense code has been stored in the message table unit 21.

If a determination is made that the static information associated with the received sense information has been stored in the message table unit 21, the error handling unit 23 transmits the acquired sense code and sub-sense code to the error message output unit 26. If a determination is made that the static information associated with the received sense information has not been stored in the message table unit 21, the error handling unit 23 transmits the acquired sense code and sub-sense code to the static information acquisition unit 24.

If a determination is made that the details of the static processing has not been stored in the message table unit 21, the static information acquisition unit 24 issues to the disk array device 10 a processing request for notification of the details of the static process associated with the type of the error indicated by the received sense information. At this time, the server 20 outputs no error message to the client 30.

More specifically, upon reception of the sense code and the sub-sense code from the error handling unit 23, the static information acquisition unit 24 generates a static information acquisition command including the received sense code and sub-sense code stored therein. In other words, if a determination is made that the details of the static processing associated with the received sense information have not been stored in the message table unit 21, the static information acquisition unit 24 generates the static information acquisition command.

Then the static information acquisition unit 24 transmits the generated static information acquisition command to the static information acquisition command reception unit 15 of the disk array device 10 to request the transmission of the static information. The static information acquisition unit 24 also transmits the sense code and the sub-sense code received from the error handling unit 23 to the static information reception unit 25. When the static information acquisition unit 24 transmits the static information acquisition command to the static information acquisition command reception unit 15, the server 20 executes an I/O queuing process and returns no error to the host program.

The static information reception unit 25 receives the details of the static processing requested by the static information acquisition unit 24. Then the static information reception unit 25 stores the received details of the static processing in the message table unit 21 in association with the type of the error.

More specifically, the static information reception unit 25 receives the retry message, retry out message, and output flag transmitted from the disk array device 10. The static information reception unit 25 also receives the sense code and the sub-sense code from the static information acquisition unit 24.

Then the static information reception unit 25 stores the received retry message, retry out message, and output flag in the message table unit 21 in association with the received sense code and sub-sense code. Next, the static information reception unit 25 transmits the sense code and the sub-sense code received from the static information acquisition unit 24 to the error message output unit 26.

For example, the static information reception unit 25 receives a retry message “Notice disk error”, a retry out message “WARN disk not empty”, and an output flag “ON”. The static information reception unit 25 also receives a sense code “4” and a sub-sense code “⅔”. Then the static information reception unit 25 stores the sense code “4” and the sub-sense code “⅔” in the message table unit 21 together with the received retry message, retry out message, and output flag so as to associate the codes with the messages and the output flag.

If a determination is made by the error handling unit 23 that the static information has not been stored in the message table unit 21, the error message output unit 26 executes the details of the static processing received by the static information reception unit 25. If a determination is made by the error handling unit 23 that the static information has been stored in the message table unit 21, the error message output unit 26 executes the details of the static processing stored in the message table unit 21.

More specifically, upon reception of the sense code and the sub-sense code from the static information reception unit 25, the error message output unit 26 acquires the static information associated with the received sense code and sub-sense code from the message table unit 21. Then the error message output unit 26 outputs the static information acquired from the message table unit 21.

Upon reception of the sense code and the sub-sense code from the error handling unit 23, the error message output unit 26 acquires the static information associated with the received sense code and sub-sense code from the message table unit 21. Then the error message output unit 26 outputs the retry message and retry out message to the client 30 according to the status of the message flag included in the received static information.

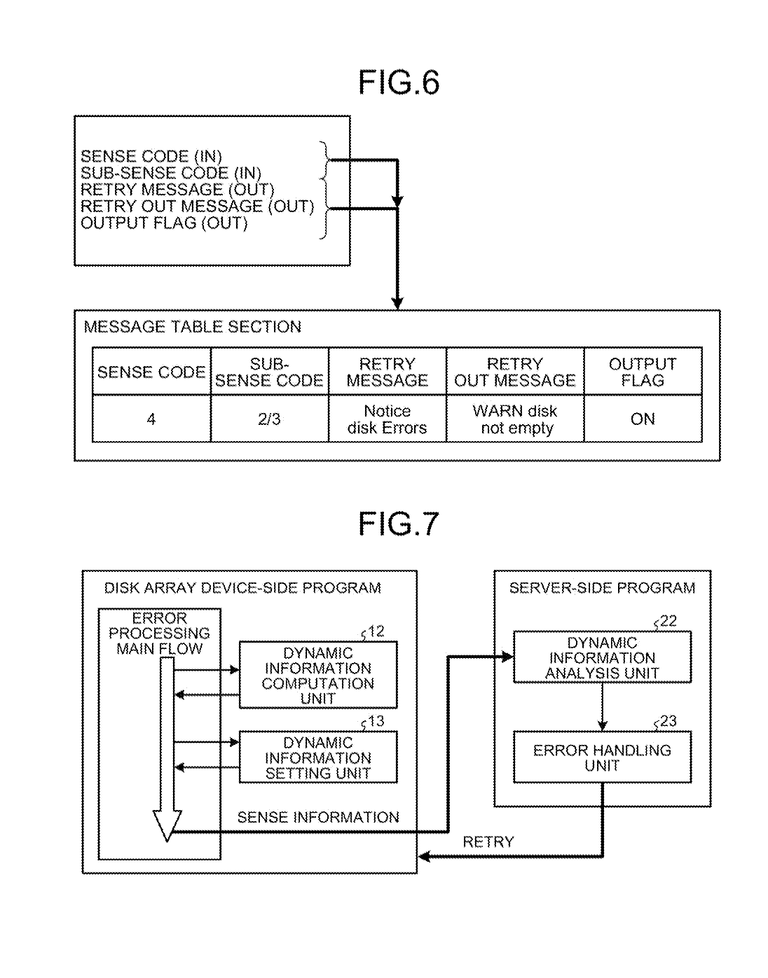

Referring next to FIG. 6, a description will be given of an example in which the error message output unit 26 outputs the retry message and the retry out message associated with the received sense code and sub-sense code to the client 30. FIG. 6 is a diagram illustrating an example of the static information.

In the example illustrated in FIG. 6, the error message output unit 26 receives “4” as the sense code (IN) and “⅔” as the sub-sense code (IN) from the error handling unit 23. In such a case, the error message output unit 26 acquires a retry message “Notice disk error” associated with the received sense code “4” and sub-sense code “⅔” from the message table unit 21.

The error message output unit 26 also acquires a retry out message “WARN disk not empty” associated with the received sense code “4” and sub-sense code “⅔” from the message table unit 21. Then the error message output unit 26 outputs the acquired retry message and retry out message to the client 30 according to the status of the output flag associated with the received sense code “4” and sub-sense code “⅔”.

Referring next to FIG. 7, a description will be given of processing for transferring dynamic information between the disk array device 10 and the server 20. FIG. 7 is a diagram illustrating the transfer of the dynamic information. In the example illustrated in FIG. 7, it is assumed that a disk array device-side program is executed on the disk array device 10 to transmit the dynamic information to the server 20. In the example illustrated in FIG. 7, it is also assumed that a server-side program is executed on the server 20 to execute the processing indicated by the received dynamic information.

In the example illustrated in FIG. 7, the disk array device-side program causes the dynamic information computation unit 12 to compute a retry number and a failover number. Next, the disk array device-side program causes the dynamic information setting unit 13 to store the computed retry number and failover number in sense information. Then the sense information including the retry number and the failover number stored therein is transmitted to the server-side program.

In the server-side program, the dynamic information analysis unit 22 analyzes the sense information received from the disk array device-side program to acquire the retry number and the failover number computed by the disk array device-side program. More specifically, in the server-side program, the dynamic information analysis unit 22 acquires the retry number and the failover number that are appropriate for the disk array device 10. Then the server-side program causes the error handling unit 23 to repeat a retry and a failover process until the acquired numbers are reached.

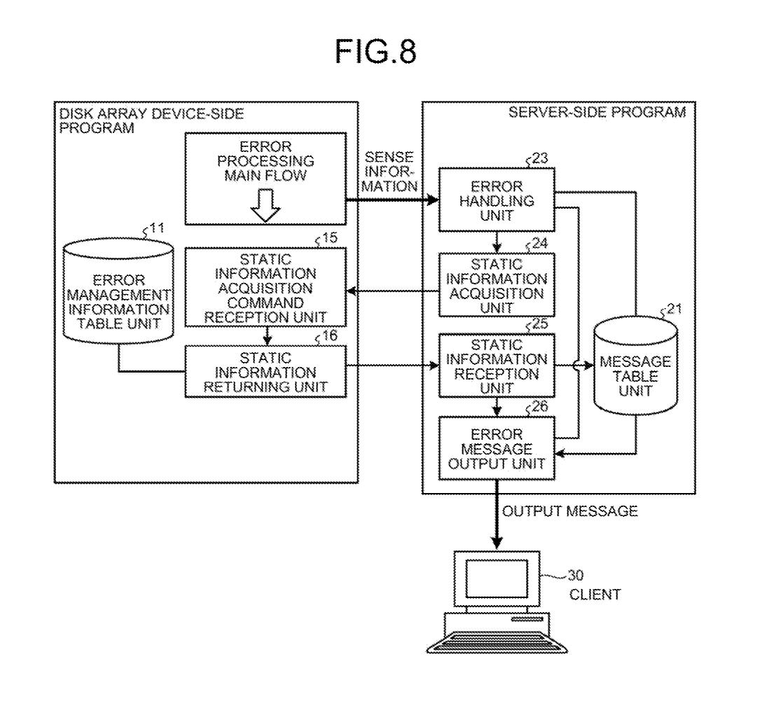

Referring next to FIG. 8, a description will be given of a processing flow for transferring static information between the disk array device and the server. FIG. 8 is a diagram illustrating the transfer of the static information. In the example illustrated in FIG. 8, the sense information generated in the error processing main flow of the disk array device-side program is transmitted to the error handling unit 23 used in the server-side program.

Upon reception of the sense information, the error handling unit 23 determines whether or not the static information (including the retry message, the retry out message, the output flag, and other information) associated with the received sense information has been stored in the message table unit 21. If a determination is made that the static information associated with the received sense information has not been stored in the message table unit 21, the error handling unit 23 notifies the static information acquisition unit 24 of the sense information. Then the static information acquisition unit 24 generates a static information acquisition command from the received sense information and transmits the generated static information acquisition command to the disk array device-side program.

Upon reception of the static information acquisition command from the server-side program, the disk array device-side program causes the static information acquisition command reception unit 15 to analyze the received static information acquisition command to extract the sense information stored in the static information acquisition command. Then the static information acquisition command reception unit 15 transmits the extracted sense information to the static information returning unit 16.

Upon reception of the sense information, the static information returning unit 16 acquires the static information associated with the received sense information from the error management information table unit 11 and transmits the acquired static information to the static information reception unit 25 used in the server-side program.

Upon reception of the static information from the disk array device-side program, the server-side program causes the static information reception unit 25 to store the received static information in the message table unit 21 in association with the sense information. Then the acquired static information is outputted to the client 30 through the error message output unit 26. More specifically, the error message output unit 26 outputs the retry message and the retry out message to the client 30 according to the status of the message output flag.

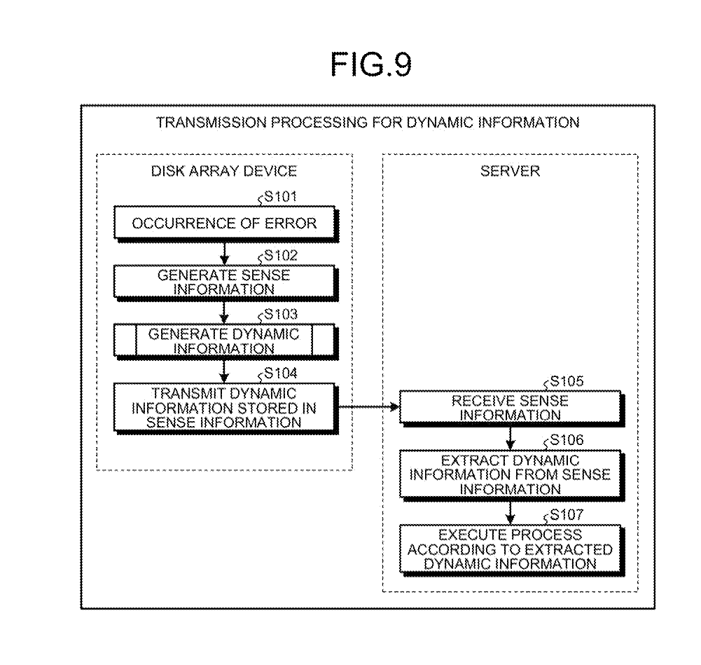

Referring next to FIG. 9, a description will be given of a processing flow executed by the storage system 100 to transmit dynamic information. FIG. 9 is a flow chart illustrating the processing for transmitting the dynamic information. Upon detection of the occurrence of an error (step S101), the disk array device 10 in the storage system 100 generates sense information that indicates the type of the error (step S102).

Next, the disk array device 10 executes a process for generating dynamic information according to the state of the disk array device 10 (step S103). Then the disk array device 10 stores the dynamic information in the addition area of the sense information and transmits the sense information including the dynamic information stored therein to the server 20 (step S104).

Upon reception of the sense information from the disk array device 10 (step S105), the server 20 analyzes the received sense information to extract the dynamic information stored in the sense information (step S106). Then the server 20 executes a process (such as a retry or a failover process) according to the extracted dynamic information (step S107). Therefore, the server 20 can repeat the retry or failover process until the appropriate retry or failover number computed by the disk array device 10 according to the state thereof is reached.

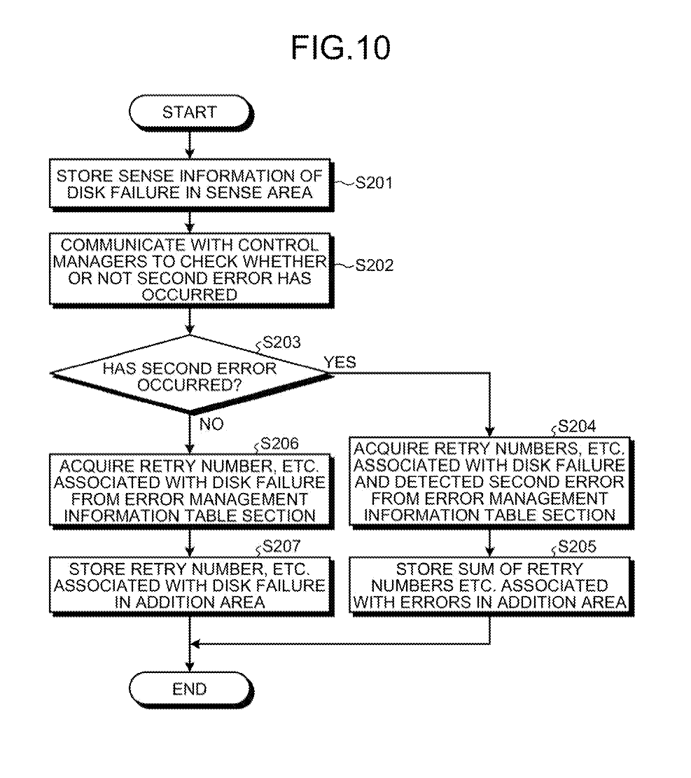

Referring next to FIG. 10, a description will be given of the processing in which the disk array device 10 generates dynamic information according to the state thereof. FIG. 10 is a flow chart illustrating the processing for generating the dynamic information. Upon generation of the sense information, the disk array device 10 starts the processing for generating the dynamic information. In the following description, it is assumed that a failure (an error) has occurred in, for example, an HDD included in the disk array device 10.

In the example illustrated in FIG. 10, the disk array device 10 stores the generated sense information for the disk failure in a sense area (step S201). For example, the disk array device 10 stores a sense code “4” and a sub-sense code “⅔” indicating the disk failure in the sense area.

Next, the disk array device 10 communicates with control managers to check whether or not a second error has occurred (step S202). Then the disk array device 10 determines whether or not a second error has occurred (step S203). If a determination is made that a second error has occurred (yes in step S203), the disk array device 10 acquires a retry number and other information associated with the type of the second error and a retry number and other information associated with the disk failure (step S204).

Then the disk array device 10 adds the acquired retry numbers together and also the acquired failover numbers together and then stores the resultant retry number and the resultant failover number in the addition area of the sense information (step S205). Then the processing in the disk array device 10 is ended.

If a determination is made that no second error has occurred (no in step S203), the disk array device 10 acquires the retry number, the failover number, and other information associated with the disk failure from the error management information table unit 11 (step S206). Then the disk array device 10 stores the acquired retry number, failover number, and other information in the addition area of the sense information (step S207).

Then the processing in the disk array device 10 is ended. In this example, the disk array device 10 adds together the retry numbers etc. associated with the types of the errors that have occurred. However, these numbers may be weighted and summed.

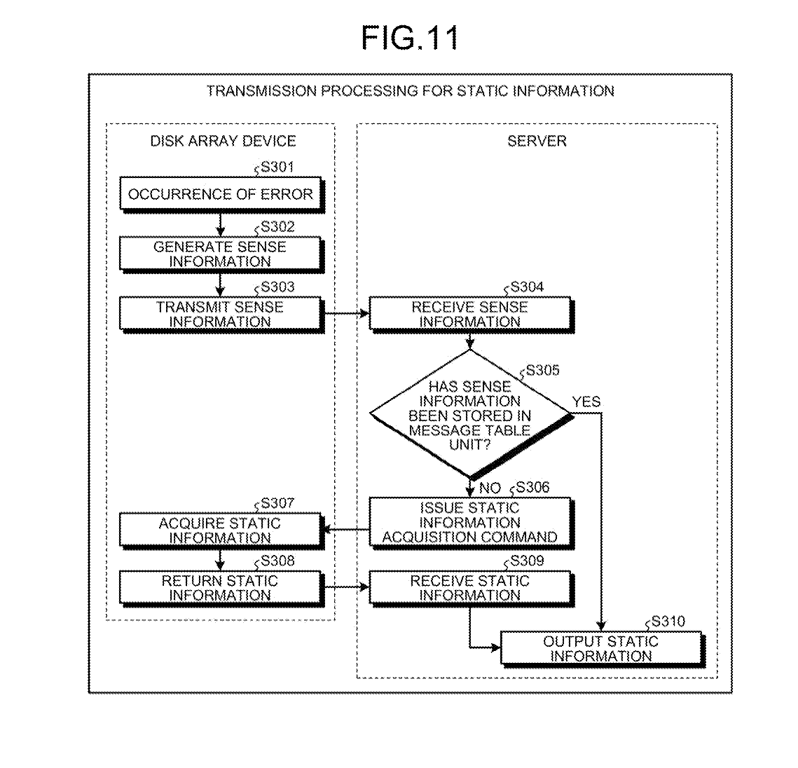

Referring next to FIG. 11, a description will be given of the processing flow executed by the storage system 100 to transmit static information. FIG. 11 is a flow chart illustrating the processing for transmitting the static information.

In the storage system 100, upon detection of the occurrence of an error (step S301), the disk array device 10 generates sense information that indicates the type of this error (step S302). Then the disk array device 10 transmits the generated sense information to the server 20 (step S303).

Upon reception of the sense information (step S304), the server 20 determines whether or not the static information associated with the received sense information has been stored in the message table unit 21 (step S305).

If a determination is made that the static information associated with the received sense information has been stored in the message table unit 21 (yes in step S305), the server 20 outputs the stored static information (step S310). More specifically, the server 20 outputs the stored retry message and retry out message according to the status of the stored output flag.

If a determination is made that the static information associated with the received sense information has not been stored in the message table unit 21 (no in step S305), the server 20 issues a static information acquisition command to the disk array device 10 (step S306). Then the disk array device 10 acquires the static information requested by the server 20 through the static information acquisition command from the error management information table unit 11 (step S307).

Then the disk array device 10 returns the acquired static information to the server 20 (step S308). Upon reception of the static information from the disk array device 10 (step S309), the server 20 stores the received static information in the message table unit 21 and outputs the received static information to the client (step S310).

Effect of Second Embodiment

As described above, the storage system 100 according to the second embodiment includes the disk array device 10 that stores error handling information in association with sense information. When an error is detected, the disk array device 10 transmits the error handling information associated with the sense information indicating the type of the detected error to the server 20. Then the server 20 controls the disk array device 10 such that processing such as a retry or a failover process is executed thereon according to the received error handling information.

Therefore, in the storage system 100, appropriate processing can be executed on the disk array device 10. More specifically, the disk array device 10 is controlled by the server 20 so as to execute processing according to the state of the disk array device 10. Therefore, the storage system 100 can execute processing appropriate for the error that has occurred in the disk array device 10. For example, even when the retry number appropriate for the disk array device 10 is different from the retry number appropriate for the disk array device 10A, the server 20 can control the disk array devices 10 and 10A such that a retry is repeated an appropriate number of times.

Moreover, in the storage system 100, the addition of new sense information and modifications to the details of processing can be made in an efficient manner. For example, in the storage system 100, when new sense information is added or error handling information is modified, only the error management information table unit 11 is modified. Therefore, in the storage system 100, since it is not necessary to reboot the server 20, the addition of new sense information and the modifications to the details of processing can be made in an efficient manner.

In the storage system 100, the server 20 transmits to the disk array device 10 dynamic information modified according to the state thereof. Therefore, in the storage system 100, processing appropriate for the disk array device 10 can be executed. In the storage system 100, for example, even if a new error occurs when an error has occurred in the disk array device 10, the server 20 can repeat a retry an appropriate number of times.

The disk array device 10 transmits only the dynamic information included in the error handling information to the server 20 together with the sense information. More specifically, the disk array device 10 stores the dynamic information in the addition area of the sense information and then transmits the resultant sense information to the server 20. Therefore, the storage system 100 can executes processing appropriate for the disk array device 10 in an on demand manner without deterioration in the I/O performance.

If a determination is made that the static information associated with the received sense information has not been stored in the server 20, the server 20 issues a request for the transmission of the static information to the disk array device 10. Upon reception of the request for the transmission of the static information from the server 20, the disk array device 10 transmits the requested static information to the server 20. Therefore, even when the retry message, retry out message, and output flag associated with the received sense information have not been stored in the server 20, the server 20 can outputs a suitable retry message and a suitable retry out message.

The server 20 stores the static information received from the disk array device 10 in association with the sense information. Therefore, when the server 20 receives the same sense information as the previously received sense information, the server 20 can control the disk array device 10 such that appropriate processing is executed without causing the disk array device 10 to transmit the static information. More specifically, the storage system 100 can execute processing appropriate for the disk array device 10 without deterioration in the I/O performance.

### [c] Third Embodiment

Although the embodiments of the present invention have been described, the invention may be embodies in various forms other than the above embodiments. In a third embodiment described below, other possible forms included in the invention will be described.

(1) Sections Included in Disk Array Device

In the second embodiment described above, the disk array device 10 includes the dynamic information computation unit 12, the dynamic information setting unit 13, and the dynamic information transmission unit 14. However, the foregoing embodiments are not limited thereto. For example, a dynamic information transmission unit 14 having the functions of the units 12 to 14 may be used. Moreover, instead of the static information acquisition command reception unit 15 and the static information returning unit 16, a static information returning unit 16 having the functions of the units 15 and 16 may be used.

(2) Programs

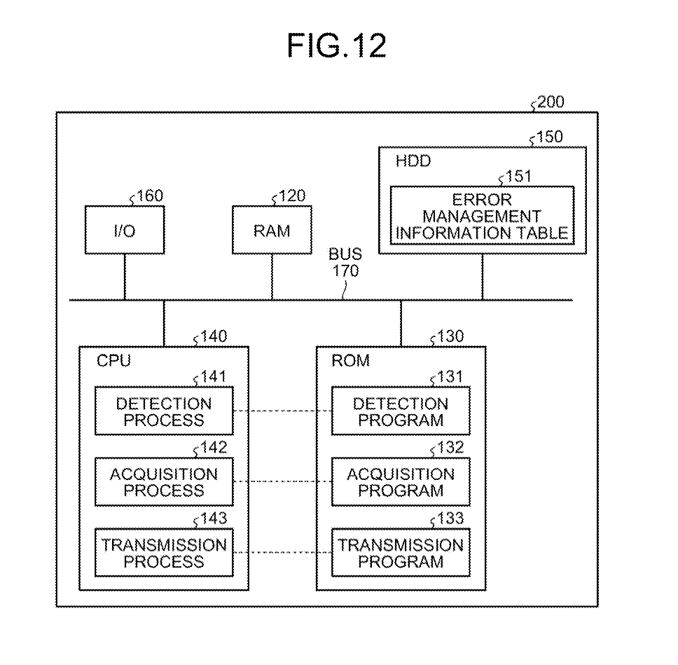

In the above description of the storage device 1 according to the first embodiment and the storage system 100 according to the second embodiment, various processes are implemented using hardware. However, the foregoing embodiments are not limited thereto. These processes may be implemented by executing preinstalled programs on a computer to transmit processing information to the server. Therefore, an exemplary computer that executes programs having the same functions as those of the storage device 1 in the first embodiment will next be described with reference to FIG. 12. FIG. 12 illustrates the exemplary computer that executes the processing programs.

A computer 200 exemplified in FIG. 12 includes a RAM (Random Access Memory) 120, a ROM (Read Only Memory) 130, and an HDD (Hard Disk Drive) 150, which are connected through a bus 170. In the computer 200 exemplified in FIG. 12, a CPU (Central Processing Unit) 140 is connected through the bus 170. An I/O (Input Output) 160 for transmitting processing information to the server is also connected to the bus 170.

An error management information table 151 for storing processing information is pre-stored in the HDD 150. The error management information table 151 includes the same information as that in the error processing information table storing unit 2 according to the first embodiment. A detection program 131, an acquisition program 132, and a transmission program 133 are pre-stored in the ROM 130. The CPU 140 reads the programs 131 to 133 from the ROM 130 and executes any of these programs. In the example illustrated in FIG. 12, these programs 131 to 133 function as a detection process 141, an acquisition process 142, and a transmission process 143, respectively. These processes 141 to 143 exert the same functions as those of the units 3 to 5 illustrated in FIG. 1. The processes 141 to 143 may exert the same functions as those of the corresponding units in the second embodiment.

The processing programs described in the above embodiment can be achieved by executing pre-installed programs on a computer such as a personal computer or a workstation. These programs can be distributed via a network such as the Internet. These programs are stored in a computer-readable recording medium such as a hard disk, a flexible disk (FD), a CD-ROM (Compact Disc Read Only Memory), an MO (Magneto Optical Disc), or a DVD (Digital Versatile Disc). These programs may be read from a recording medium by a computer and then executed.

In one embodiment of the disclosed technology, processing appropriate for an error in a storage device can be executed, and the addition of new processing details and modifications to processing details can be made in an efficient manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
an error processing information table storing unit that stores a table that associates types of possible errors that can occur in the storage device with details of processes to be executed when the possible errors occur;
a determination unit that detects occurrence of an error in the storage device and determining a type of the error in the storage device;
an acquisition unit that acquires, from the error processing information table storing unit, the details of the stored process associated with the type of the error that is determined by the determination unit; and
a transmission unit that transmits the details of the process acquired by the acquisition unit to a control device that controls the storage device.

2. The storage device according to claim 1, wherein
the error processing information table storing unit stores, as the details of the processes to be executed, dynamic information indicating processing details of a process that can be modified according to a state of the storage device each time an error is detected,
the acquisition unit acquires, from the error processing information table storing unit, the stored dynamic information associated with the type of the error that is determined by the determination unit, and
the transmission unit transmits the dynamic information acquired by the acquisition unit to the control device.

3. The storage device according to claim 2, wherein
the transmission unit transmits the dynamic information to the control unit together with error information including information indicating the type of the error that is determined by the determination unit.

4. The storage device according to claim 1, wherein
the error processing information table storing unit stores, as the details of the processes to be executed, static information indicating processing details predetermined for each of the types of the possible errors, and
the storage device further comprises a static information transmission unit for, when the static information is requested by the control device, transmitting to the control device the details of a static process associated with the type of the error that is notified.

5. The storage device according to claim 4, wherein
the transmission unit transmits the dynamic information to the control unit together with error information including information indicating the type of the error that is determined by the determination unit.

6. A storage system comprising a storage device that stores information and a control device that controls the storage device, wherein
the storage device includes
an error processing information table storing unit that stores a table that associates types of possible errors that can occur in the storage device with details of processes to be executed when the possible errors occur,
a determination unit that detects occurrence of an error in the storage device and determining a type of the error in the storage device,
an acquisition unit that acquires, from the error processing information table storing unit, the details of the stored process associated with the type of the error that is determined by the determination unit, and
a transmission unit that transmits the details of the process acquired by the acquisition unit to the control device, wherein
the control device includes a control unit that, upon reception of the details of the process transmitted from the storage device, controls the storage device such that the received details of the process are executed.

7. A control method comprising:
detecting a type of an error that occurs in a device to determine the type of the error;
acquiring, from an error processing information table storing device that stores a table that associates types of possible errors that can occur in the device with details of processes to be executed when the possible errors occur, the details of the stored process associated with the type of the error that is determined; and
transmitting the details of the process acquired at the acquiring to a control device that controls the device.
